(19) United States
(12) Patent Application Publication
(10) Pub. No.: US 2004/0148778 A1
(43) Pub. Date: Aug. 5, 2004

(54) Method for manufacturing a vehicle frame assembly

(76) Inventor: Sean M. Fleming, Buchanan, VA (US)

Correspondence Address: Joseph J. Jochman, ANDRUS, SCEALES, STARKE & SAWALL, LLP, Suite 1100, 100 East Wisconsin Avenue, Milwaukee, WI, 53202-4178, US

(21) Appl. No.: 10/745,038

(22) Filed: Dec. 23, 2003

Related U.S. Application Data
(63) Continuation-in-part of application No. 10/355,313, filed on Jan. 31, 2003, now Pat. No. 6,681,489.

(51) Int. Cl. B23P 17/00

(52) U.S. Cl. 29/897.2; 29/421.1

(57) ABSTRACT

A vehicle frame assembly, including a pair of sidebars, interconnecting crossbars and optional connecting brackets all formed from channel sections, is manufactured using soft adjustable tooling, preferably a roll former, thereby eliminating the need to use hard tooling. The shorter frame assembly components, including the crossbars and optional brackets, are formed as multi-piece gang members. The frame may be assembled with mechanical fasteners (bolts or rivets) or by welding, the latter obviating the need to use brackets. When mechanical fasteners are used, the components are hole-punched, preferably with numerically controlled piercing equipment. When heat treated steel is used, the piercing and cutting operations are preferably performed after heat treating.

This is a continuation-in-part of application No. 10/355,313, filed Jan. 31, 2003.

### BACKGROUND OF THE INVENTION

The present invention pertains to the manufacture of the components for a vehicle frame assembly and, more particularly, to the forming of frame sidebars, crossbar members and optionally, bracket members, all comprising channel sections.

The present invention relates to the preferred use of a computer controlled roll former and an associated computer controlled hole punching apparatus to form the sidebar components, ganged bracket members, and ganged crossbar members, with the ganged members cut to form individual brackets and crossbars after all the preliminary forming is completed. However, optional forming means may also be used.

A typical frame member for a vehicle chassis includes a pair of parallel sidebars or side rails connected by transverse crossbars with the connections effected by brackets if the connections are made by bolting or riveting. Welded frames may not require connecting brackets. However, in the heavy truck industry, bolted connections are preferred and predominate. The use of welded frames is generally limited to light trucks.

For many years, truck fame components were formed primarily by stamping individual pieces utilizing hard tooling designed to form sequentially identical component parts. Truck frame components are typically made of channel members, but within a particular frame assembly, both the size and the gauge of the channels for the respective sidebars, crossbars and brackets may vary. Thus, three or more sets of hard tooling may be required for stamping the components of a typical frame assembly. For a bolted (or riveted) frame assembly, the bolt holes are punched in the individual components after the components are stamped and often prior to final heat treating. Because the bolt holes may be punched with different punching apparatus, there is often a problem of bolt hole match-up at assembly. In addition, heat treating the components after the holes have been punched may result in further changes in bolt hole position and/or size.

All of the foregoing problems may be compounded where the components are supplied by more than one manufacturer or are made at different locations. In addition, truck manufacturers often desire essentially identical frame members in an order to be provided with varying bolt hole patterns depending on the engine, truck body and other intended uses for a particular frame. This also propounds the problems of bolt hole position and match-up.

Even in the manufacture of a welded frame assembly, where connecting brackets may not be utilized, there is utility and importance in forming the crossbars as initial ganged crossbar members. Both dimensional accuracy and productivity are enhanced by utilizing ganged crossbar members and, if needed, ganged bracket members as well. Although practice of the present invention lends itself particularly well to formation of the frame members in a continuous roll forming apparatus, ganged members, both crossbars and brackets, may also be formed in more conventional soft-tooled equipment such as a press brake or a universal stamping/forming tool. These machines may be operated either automatically or manually, all while preserving the basic benefits of ganged part formation.

### SUMMARY OF THE INVENTION

In accordance with one embodiment of the present invention, a vehicle frame assembly, comprising sidebars, crossbars and connecting brackets, is manufactured using a computer controlled flexible roll former that eliminates the need for hard tooling. The shorter frame assembly components, namely the crossbars and the brackets, are formed as multi-piece gang members that are hole-punched and, if necessary, offset-formed before being cut into respective individual crossbars and brackets.

In one embodiment of the method of the present invention, the method comprises the steps of (1) forming a steel strip in the roll former to a first channel shape, (2) cutting the first channel shape to provide a sidebar, (3) adjusting the roll former and forming a steel strip to a second channel shape, (4) cutting the second channel shape to provide a multi-bracket gang member, (5) adjusting the roll former and forming a steel strip to a third channel shape, (6) cutting the third channel shape to provide a multi-crossbar gang member, (7) punching a plurality of attachment holes in the sidebars, in the bracket gang member, and in the crossbar gang member, and (8) cutting the bracket gang member and the crossbar gang member to provide respective individual brackets and crossbars.

In one variation of the foregoing method, each of the forming steps is performed on the same strip. The method may also include the step of heat treating the sidebars, the bracket gang member, and the crossbar gang member before punching. Preferably, the method comprises cutting the first channel shape to provide a plurality of pairs of sidebars, cutting the second channel shape to provide a plurality of bracket gang members, and cutting the third channel shape to provide a plurality of crossbar gang members.

In a further variation of the present invention, vehicle frame assemblies each including a pair of sidebars, a plurality of crossbars for interconnecting the sidebar pair, and a plurality of connection brackets, all formed of channel sections, are manufactured by a method comprising the steps of (1) forming sidebars, ganged bracket members, and ganged crossbar members utilizing an adjustable computer controlled roll former, (2) heat treating, if necessary, the sidebars, bracket members and crossbar members, (3) punching connection holes in the sidebars, bracket members and crossbar members utilizing a computer controlled punch, and (4) cutting the bracket members and crossbar members to form individual brackets and crossbars.

This variant method may also include the step of, prior to cutting the crossbar members, forming offset portions at selected positions of the crossbar members. The offset portions are preferably formed at crossbar end positions defined by the subsequent cutting step. The offset forming step may comprise vertical offsetting or horizontal offsetting.

A further embodiment of the method of the present invention comprises manufacturing a plurality of vehicle frame assemblies, each including a pair of sidebars, a plurality of crossbars and a plurality of brackets, including the steps of (1) forming the sidebars to individual cut lengths, (2) forming the crossbars and the brackets, respectively, in initial ganged crossbar members and ganged bracket members, (3) punching the sidebars, crossbar members, and bracket members in a computer controlled punch device to form connection holes, and (4) cutting the crossbar members and the bracket members to form individual crossbars and brackets.

Preferably, the forming step of the foregoing method comprises roll forming. The roll forming step preferably utilizes a computer-controlled adjustable roll former. The method may also include the step of heat treating the sidebars, crossbar members and bracket members prior to punching. The heat treating step is preferably performed after the roll forming step.

In accordance with the basic method of the present invention, a vehicle frame assembly, comprising sidebars and crossbars, is manufactured using gang forming for at least some of the components. The shorter frame assembly components, namely the crossbars, are formed as multi-piece ganged members and, if necessary, offset-formed before being cut into individual crossbars. The basic method comprises the steps of (1) forming the sidebars to individual cut lengths, (2) forming the crossbars in initial ganged crossbar members, (3) cutting the crossbar members to form individual crossbars, and (4) connecting the sidebars with the crossbars.

If the frame assemblies utilize mechanical fasteners and brackets to provide the component interconnections, the method may also include the steps of (1) forming the brackets in initial ganged bracket members, (2) forming connection holes in the sidebars, crossbar members and bracket members, (3) cutting the bracket members to form individual brackets, and (4) utilizing the brackets to connect the sidebars to the crossbars. Preferably, the connection holes are formed by punching and the brackets are utilized to connect the sidebars to the crossbars with bolted connections.

The forming step preferably comprises roll forming, and the method may also include the step of heat treating the sidebars, crossbar members and bracket members prior to forming the connection holes.

In a variant of the basic method wherein the frame assembly includes a plurality of brackets, the method includes the steps of (1) forming the brackets in initial ganged bracket members, (2) forming connection holes in the sidebars, crossbar members and bracket members, (3) cutting the bracket members to form individual brackets, and (4) utilizing the brackets to connect the sidebars to the crossbars. The step of forming connection holes may comprise any one of the steps of punching, drilling, and thermal cutting. The method for utilizing the brackets to connect the sidebars to the crossbars preferably comprises bolting or riveting.

The basic method of the present invention may alternately utilize the connecting step of welding. In this case, the forming step also preferably comprises roll forming. In a variation of the basic method to provide a welded frame assembly, a plurality of second crossbars are used and combined with the initial crossbars to form composite box-like crossbars. In particular, the method includes the additional steps of (1) forming the sidebars, the ganged crossbar members, and second ganged crossbar members in the shape of channel sections, the channel sections of the crossbar members being larger in cross-sectional size than the second crossbar members, (2) cutting the second ganged crossbar members to form individual second crossbars, (3) forming a composite crossbar of a second crossbar within a crossbar, and (4) connecting the composite crossbar to the sidebars by welding.

### BRIEF DESCRIPTION OF THE DRAWINGS

FIG. 1 is a side elevation view of a vehicle frame sidebar, bracket gang member, and crossbar gang member formed in accordance with the method of the present invention.

FIG. 2 is a perspective view of a portion of a vehicle frame assembled with the components formed in accordance with the present invention.

FIG. 3 is an enlarged sectional detail taken on line 3-3 of FIG. 2.

FIG. 4 is an enlarged sectional detail taken on line 4-4 of FIG. 2.

FIG. 5 is a schematic process flow diagram for the manufacture of a frame assembly in accordance with the present invention.

FIG. 6 is a perspective view of a frame assembled with the components made in accordance with the process of FIG. 5.

FIG. 7 is a side elevation view of a vehicle frame sidebar, a larger section crossbar gang member, and a smaller section crossbar gang member formed in accordance with a further embodiment of the present invention.

FIG. 8 is a side elevation detail, partly in section, showing a welded construction utilizing crossbars cut from one of the crossbar members of FIG. 7.

FIG. 9 is a sectional detail taken on line 9-9 of FIG. 8.

FIG. 10 is a side elevation detail, partly in section, showing a further embodiment of a welded construction utilizing crossbars cut from both of the crossbar members of FIG. 7.

FIG. 11 is a section taken on line 11-11 of FIG. 10.

FIG. 12 is a perspective view of a vehicle frame utilizing the crossbar construction of FIGS. 10 and 11.

### DETAILED DESCRIPTION OF THE PREFERRED EMBODIMENTS

In a roll former, structural shapes may be formed from rolls of flat strip steel or other metals by moving the strip through progressive tooling to change the shape of the strip to, for example, a channel shape. Channel members so formed may be continuously produced and cut to length with a flying shear, all in a manner known in the art. In accordance with the method of the present invention, to be described in detail hereinafter, an automated flexible roll forming system, of the type made, for example, by Stam Spa (Italy) is used to form three different channel member components for a vehicle frame assembly and is combined with a computer controlled punch or piercing apparatus, and optimally other offsetting devices, to form the frame components in an extremely accurate and cost effective way.

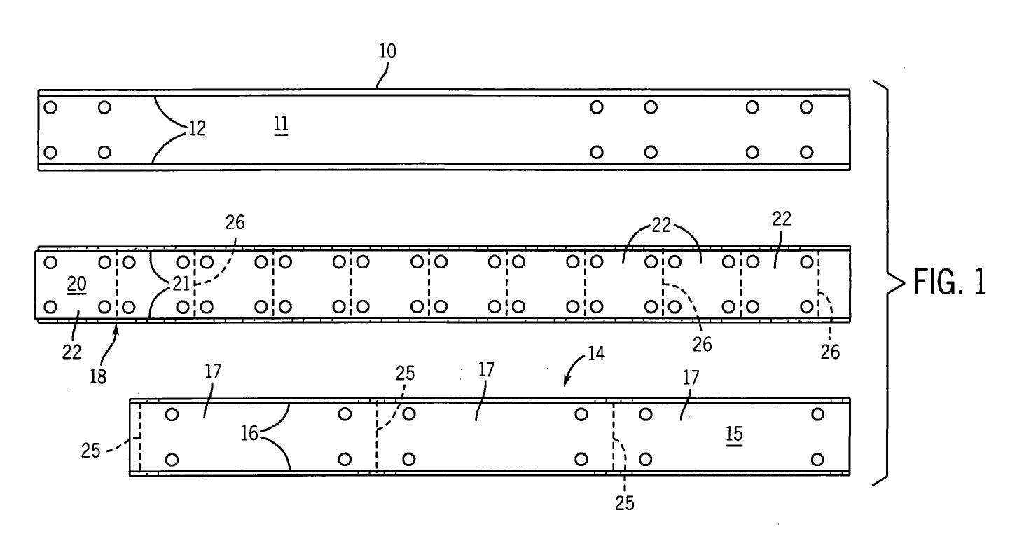

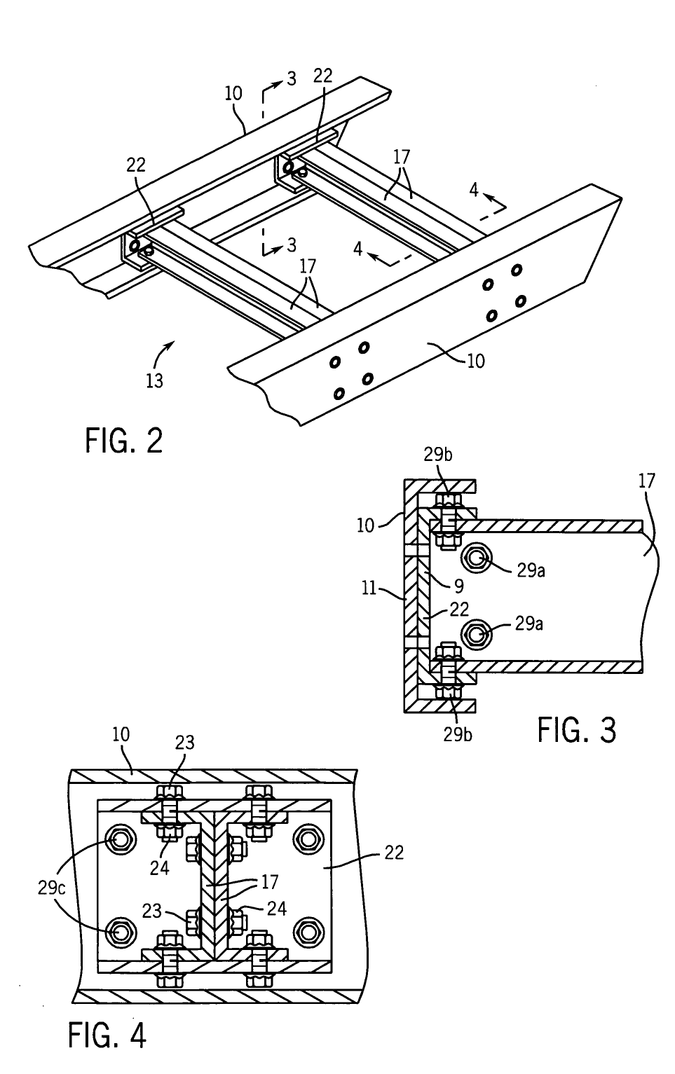

FIG. 1 shows the three master components of a vehicle frame assembly after they have been initially roll formed, heat treated if necessary, and pierced to form the holes for bolts or rivets used to assemble the frame. Each of the elements shown in FIG. 1 comprises a channel member. One component comprises a sidebar 10 of a conventional channel section, including a central web 11 and opposite end flanges 12. To produce a complete frame 13, as shown in part in FIG. 2, two sidebars 10 are required. The sidebars are individually cut to length as they exit the roll former, preferably utilizing a flying shear as indicated above. The lower component in FIG. 1 is a crossbar gang member 14 which is formed similarly to the sidebar 10 but may have different dimensions for its web 15 and flanges 16, and may be formed from a different gauge steel strip. The crossbar gang member 14 is formed to any convenient length in the roll former, resulting in multiple crossbars 17 subsequently provided in a cutting operation which will be described below. Although a crossbar gang member 14 having three potential crossbars 17 is shown in FIG. 1, a roll former may be capable of producing a member having a length, for example, of about 40 feet from which up to 16 crossbars 17 may be subsequently cut.

The middle member in FIG. 1 comprises a bracket gang member 18 which, like the sidebar 10 and crossbar gang member 14, is roll formed to a channel section including a web 20 and flanges 21. The bracket gang member 18 may be heat treated after forming, if necessary, hole punched in a computer controlled piercing apparatus and subsequently cut to short lengths to form connecting brackets 22 utilized to attach the crossbars 17 to the sidebars 10 in the assembly of the frame 13.

FIGS. 3 and 4 show how flange head bolts 23 and related flange head nuts 24 are used to connect the crossbars 17 to the sidebars 10, utilizing brackets 22. Specifically, the frame 13 is assembled with the following bolted connections, as shown in FIGS. 3 and 4. A pair of crossbars 17 is bolted back-to-back with bolted connections 29a. This crossbar subassembly is connected to a bracket 22 by bolted connections 29b interconnecting the crossbar flanges 16 to the bracket flanges 21. Finally, the brackets are bolted to the sidebars 10 with bolted connections 29c attaching their respective webs 20 and 11. In these figures, it will be noted that the web 11 of the sidebar 10 has the greatest width, the web 14 of the crossbar 17 has the smallest width, and the web 20 of the bracket 18 has an intermediate width. Other frame assemblies may use channel components with web (and flange) dimensions that are relatively different.

It is important to note, however, that regardless of variations in the sizes of the webs, the heights of the flanges, or the gauge of the material strip from which the channel pieces are formed, each of the profiles for the sidebars 10, crossbar gang members 14, and bracket gang members 18 can be programmed into the computer controlled roll former to automatically provide the desired shape and size. No custom hard tooling is required and, consequently, once programmed, there is no tooling changeover required when going from one shape to another. Instead, the computer controlled roll former permits on-the-fly change from one roll-formed shape to the next, thereby permitting the continuous manufacturer of an order of any desired size of sidebars 10, crossbar gang members 14 and bracket gang members 18.

The roll forming process may utilize ultra high strength low alloy steel (UHSLA), such as that having a yield strength in excess of 100 ksi. Preferably, however, lower yield strength steel, in the range of 30-50 ksi, is used. After various channel members 10, 14 and 18 are formed, they are heat treated to raise the yield to, for example, in excess of 100 ksi, using a conventional heat treating process, including austinitizing and quenching. One such heat treating process is described in U.S. Pat. No. 6,488,791. After heat treat, the component pieces 10, 14 and 18 are punched to form connecting bolt holes in a computer controlled piercing apparatus of the mechanical type made, for example, by Beatty Machine Co. (US) or the hydraulic type made, for example, by Soenen (Belgium). The piercing or punching operation provides accurate control of the hole locations and permits ready changes in bolt hole locations for special customized order criteria. Forming the bolt holes after heat treat avoids the possibility of bolt hole location or size deviations as the result of growth in heat treating. Bolt hole accuracy and alignment, and ease of fit-up, are all enhanced as a result of this process.

Referring again to FIG. 1, after the bolt holes have been formed, both the crossbar gang members 14 and the bracket gang members 18 are cut on the respective cut lines 25 and 26 form the final crossbars 17 and brackets 22. Cutting may be provided by conventional sawing devices, by plasma or laser cutting, or some other method. The component pieces 10, 17 and 22 are ready for assembly using the bolted connectors 23 and 24 as shown in FIGS. 2-4.

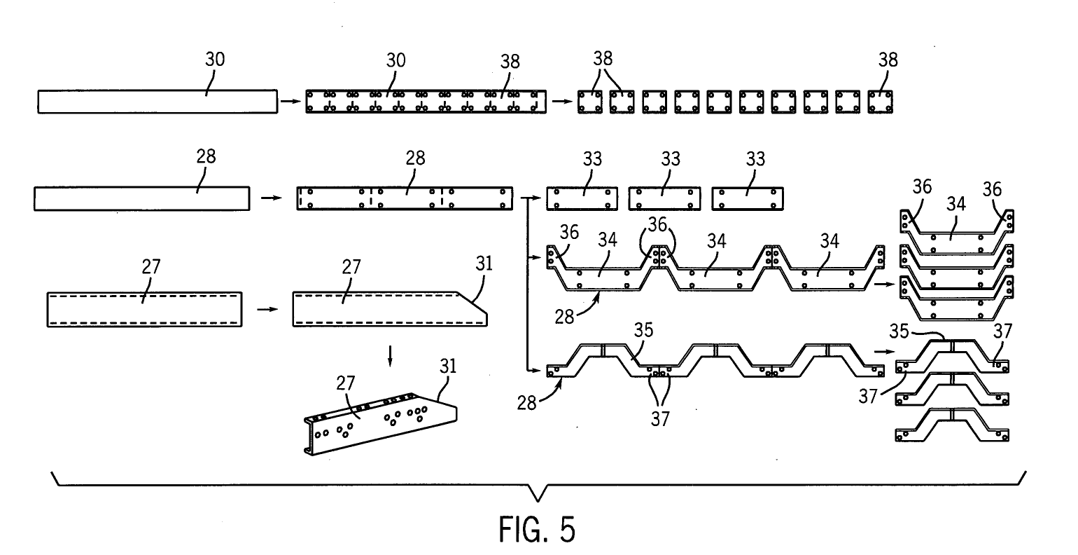

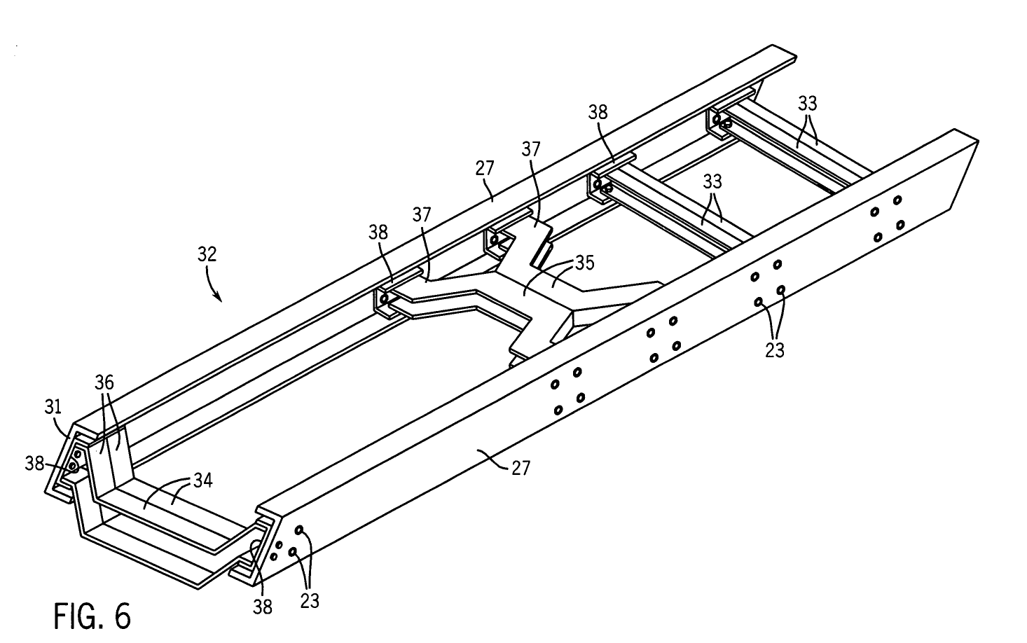

Referring now to FIG. 5, there is shown a process flow for a somewhat more complex frame manufacturing process and, in FIG. 6, there is shown a truck frame assembled from the components of the FIG. 5 process. The computer controlled roll former is set and operated to roll form the sidebars 27, the crossbar gang members 28 and the bracket gang members 30 all in a manner similar to that described above. If desired, each of the members 27, 28 and 30 may be heat treated. The front edge of the sidebars 27 may be trimmed, as with a trim cut 31, depending on the truck manufacturer's requirements. The bolt holes are then punched in the web of the sidebars 27, leaving them ready for assembly into the frame 32 shown in FIG. 6. With reference to FIG. 6, the frame 32 includes three different types of crossbars, namely, straight crossbars 33, vertically offset crossbars 34 and horizontally offset crossbars 35. Such various crossbars may be required to meet a truck manufacturer's particular requirements for strength, engine position, and other requirements. The vertically offset ends 36 in crossbars 34 and the horizontally offset ends 37 in crossbars 35 are formed in the ganged configuration of member 28. This offsetting process may be performed without the use of special hard tooling and dies in a computer controlled forming apparatus, such as a hydraulic offsetting press made, for example, by Stenhoj A/S (Denmark). The offsetting steps may also be performed after the connecting holes have been punched in the crossbars without loss of accuracy in bolt hole position.

The assembled truck frame 32, shown in FIG. 6, includes a pair of sidebars 27 each having a trim cut 31 on the front edge, immediately to the rear of which are attached a pair of vertically offset crossbars 34. The crossbars 34 are attached at their offset ends 36 to the sidebars 27 by the use of brackets 38 cut from the bracket gang members 30 in the same manner previously described. Near the center of the frame 32, a pair of back-to-back horizontally offset crossbars 35 are attached by their offset ends 37 to the sidebars 27, using brackets 38. Finally, at the rear of the frame, two longitudinally spaced pairs of straight crossbars 33 are attached at their opposite ends between the sidebars 27, again utilizing connecting brackets 38. All of the foregoing connections are preferably effected with the same type of bolt and nut assemblies 23, 24 described above. Riveted connections may also be used.

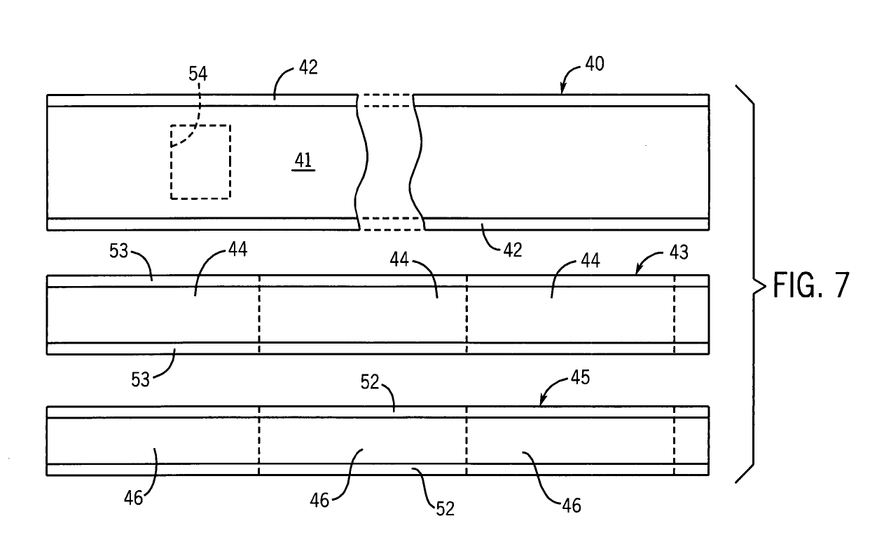

FIG. 7 shows the three master components of another vehicle frame assembly after they have been initially formed and heat treated, if necessary, prior to assembly by welding. Although the method of the present invention preferably utilizes roll forming to form the various channel members, it is to be understood that the invention encompasses the use of any type of soft-tooled arrangement, i.e. adjustable tooling which does not require a specific set of hard tools for each of the frame members, including the ganged members as will be described. Thus, in addition to roll forming, ganged frame members may also be formed in a press brake or a universal stamping/forming tool of a type well known in the industry.

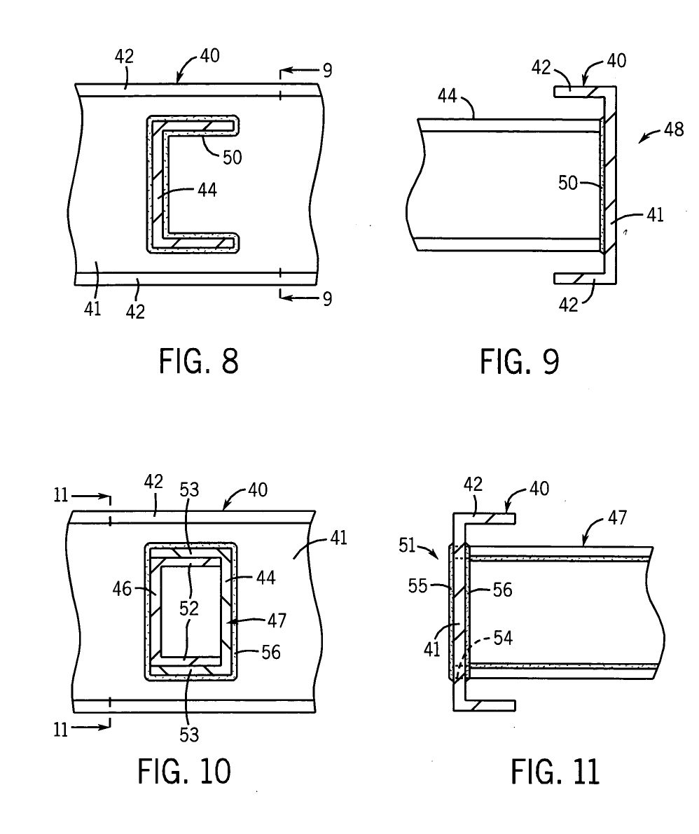

The FIG. 7 components include a sidebar 40 of a conventional channel section, including a central web 41 and opposite end flanges 42. The sidebar 40 is the largest of the three sections shown in FIG. 7. The components also include a first larger ganged crossbar member 43, used by itself to form the crossbars 44 for the welded assembly shown in FIGS. 8 and 9, and a second smaller ganged crossbar member 45 used to produce the crossbars 46 which are combined with crossbars 44 to form composite box crossbars 47 used in the welded frame assembly shown in FIGS. 10 and 11.

In a manner similar to that described with respect to the FIG. 1 embodiment, each of the sidebars 40 is individually cut to length as it exits the roll former or other soft-tooled forming machine. The larger ganged crossbar member 43 is formed to any convenient length in the roll former, resulting in a member from which three crossbars 44 may be subsequently cut. Similarly, the smaller ganged crossbar member 45 is also formed to any convenient length resulting in a member having multiple crossbars 46 of which there are three in the example shown in FIG. 7. As with the previously described embodiment, a roll former may be capable of producing a ganged crossbar member 43 or 45 having a length, for example, of about 40 feet (about 16 m) from which 15 or more crossbars 44 or 46 may be subsequently cut.

Referring also to FIGS. 8 and 9, a detail of a welded frame assembly is shown that utilizes sidebars 40 and crossbars 44. Each crossbar 44 is butt welded at opposite ends to the central webs 41 of a pair of parallel sidebars 40 (a part of only one of which is shown in the drawings). The weld 50 is preferably continuous, following the entire section of the crossbar 44. Any convenient thermal joining technique may be used, including MIG, TIG, arc-welding, STIR-welding or a chemical joining technique.

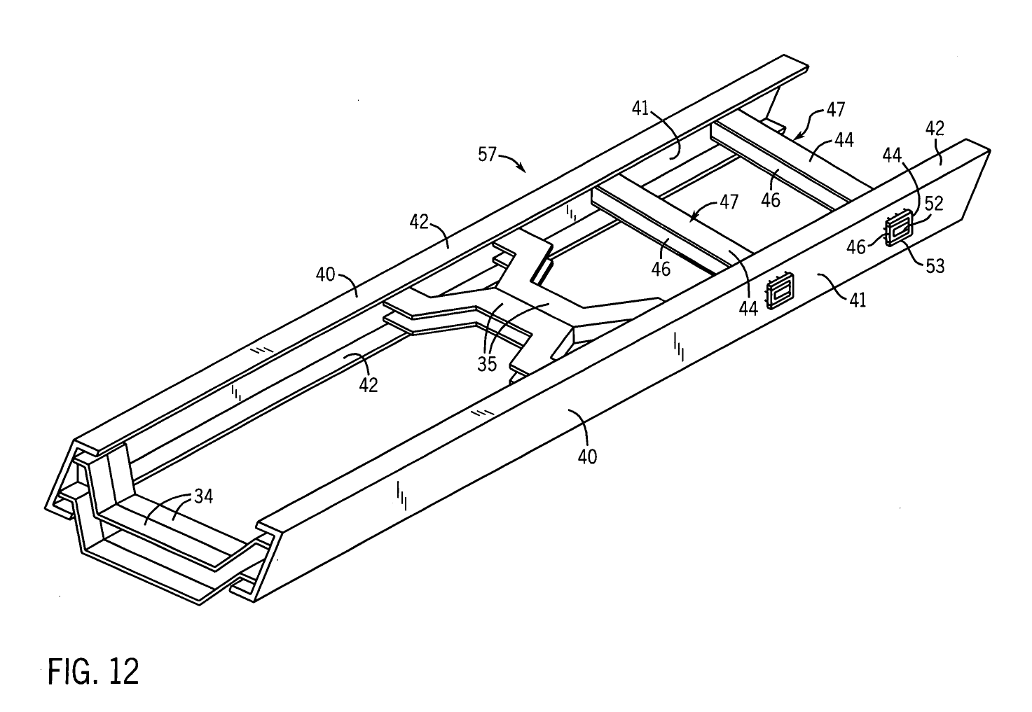

In FIGS. 10 and 11 there is shown a detail of another welded frame assembly 51 which uses composite box crossbars 47, also welded between a pair of parallel sidebars 40, only one of which is shown. The smaller ganged crossbar member 45 is formed with a section small enough such that the end flanges 52 of the smaller crossbar 46 fits snuggly within the end flanges 53 of the larger crossbar 44 to form the box-like crossbar 47. The central web 41 of the sidebar 40 is cut to form a rectangular opening 54 (see FIG. 7) just large enough to provide clearance for the box crossbar 47. The crossbar 47 is then securely fastened to the web 41 of the sidebar 40 with outer and inner perimeter welds 55 and 56. In FIG. 12, there is shown a vehicle frame assembly 57 utilizing a pair of box crossbars 47 of the type shown in FIGS. 10 and 11 and described above. The box crossbars 47 are welded to the sidebars 40 and the remainder of the frame assembly includes a pair of vertically offset crossbars 34 and a pair of horizontally offset crossbars 35, all of which are welded to the sidebars 40. The frame assembly 57 is thus very similar to that shown in the FIG. 6 embodiment, but the bolted connections have been replaced with welds.

The roll forming apparatus described herein can form various size channel members from steel strip to provide sidebars, crossbar gang members and bracket gang members with web widths in a range of about 5 inches to 13 inches, and with flange heights in the range of about 2 inches to 4½ inches. Steel strip with gauges varying from 3/16 inch to 7/16 inch may be processed. The aforementioned dimensional ranges are typical, although if the application requires may extend beyond these ranges. The soft tooling used in the computer controlled roll former permits on-the-fly changes from one channel size to another and, if a gauge change is required for a channel size change, the strip roll change may be effected simply and in a short time. The customer does not have to purchase custom hard tooling nor is there the customary hard tooling change over required when changing channel sizes as would be required in a conventional stamping operating. The entire process is extremely flexible, accurate, fast and cost-effective.

I claim:

1. A method for manufacturing a plurality of vehicle frame assemblies, each including a pair of sidebars and a plurality of crossbars, said method comprising the steps of:
(1) forming the sidebars to individual cut lengths;
(2) forming the crossbars in initial ganged crossbar members;
(3) cutting the crossbar members to form individual crossbars; and,
(4) connecting the sidebars with the crossbars.

2. The method as set forth in claim 1 wherein the frame assembly includes a plurality of brackets, and including the steps of:
(1) forming the brackets in initial ganged bracket members;
(2) forming connection holes in the sidebars, crossbar members and bracket members;
(3) cutting the bracket members to form individual brackets; and,
(4) utilizing the brackets to connect the sidebars to the crossbars.

3. The method as set forth in claim 2 wherein the connection holes are formed by punching.

4. The method as set forth in claim 2 including the step of utilizing the brackets to connect the sidebars to the crossbars with bolted connections.

5. The method as set forth in claim 2 wherein the forming steps comprises roll forming.

6. The method as set forth in claim 2 including the step of heat treating the sidebars, crossbar members and bracket members prior to forming the connection holes.

7. The method as set forth in claim 1 wherein the frame assembly includes a plurality of brackets, and including the steps of:
(1) forming the brackets in initial ganged bracket members;
(2) forming connection holes in the sidebars, crossbar members and bracket members;
(3) cutting the bracket members to form individual brackets; and,
(4) utilizing the brackets to connect the sidebars to the crossbars.

8. The method as set forth in claim 7 wherein the step of forming the connection holes is selected from the steps of punching, drilling, and thermal cutting.

9. The method as set forth in claim 8 wherein the connections utilizing the brackets to connect the sidebars to the crossbars comprises bolting or riveting.

10. The method as set forth in claim 1 wherein the connecting step comprises welding.

11. The method as set forth in claim 10 wherein the forming step comprises roll forming.

12. The method as set forth in claim 1 wherein each vehicle frame assembly further includes a plurality of second crossbars, and including the additional steps of:
(1) forming the sidebars, the ganged crossbar members, and second ganged crossbar members in channel sections, the channel sections of the crossbar members being larger in cross-sectional size than the second crossbar members;
(2) cutting the second ganged crossbar member to form individual second crossbars;
(3) forming a composite crossbar of a second crossbar within a crossbar; and,
(4) connecting the composite crossbar to the sidebars by welding.
